(19) United States
(12) Patent Application Publication
(10) Pub. No.: US 2001/0036178 A1
(43) Pub. Date: Nov. 1, 2001

(54) Telecommunications switch with programmable call processing and real time account management for switching and billing all common informational protocols on a single switch and network

(76) Inventor: Jessel Savory, Chandler, AZ (US)

Correspondence Address: Jessel Savory, 314 PHILADELPHIA AVE., TAKOMA PARK, MD, 20912, US

(21) Appl. No.: 09/736,385

(22) Filed: Dec. 15, 2000

Related U.S. Application Data
(63) Continuation-in-part of application No. 09/024,495, filed on Feb. 17, 1998, now abandoned.

(51) Int. Cl. H04L 12/50; H04L 12/28

(52) U.S. Cl. 370/364; 370/395; 370/400; 370/352; 370/474

(57) ABSTRACT

A combination of data communication and transfer protocols to produce a switching system that is intelligent, versatile, economical, and programmable. Specifically, utilizing solely PCI based data communicating bus and the ATM switching protocol, the instant invention is categorically a “virtual matrix” system and design using both hardware and software. The use of the PCI bus based computer and the ATM switching devices along with accounting and call processing software provides the ability to recognize an incoming call in any protocol and least cost route it out on any available port, and book and bill it in real time. The present invention is a comprehensive, flexible scalable, and expandable package providing a high level of performance. In the telephone/cable industry, the ability to do real time processing, rating, and billing of calls and digital services in any protocol in a sole computer based system is a key component to effective service. The present invention stores data in random access memory and uses interprocess communications between software modules instead of database access on disk. A standard personal computer used as a host computer having a PCI bus based switch system processes telecommunications/digital information at least 10 orders of magnitude faster than conventional indexed database access systems.

This is a Continuation-In-Part Application of CPA Ser. No. 09/024,495 filed on Apr. 19, 2000, which was filed based on patent application Ser. No. 09/024,495 filed on Feb. 17, 1998.

### BACKGROUND OF THE INVENTION

1. Field of the Invention

The present invention relates to a telecommunications system having a Peripheral Component Interconnect (PCI) based host with the ability to recognize an incoming call in any protocol and least cost route it out on any available port through a switch computer providing programmable call processing and real time billing.

2. Description of Related Art

There are many devices in the related art for providing telephone switching circuits at an accelerated speed or transfer. These switching devices are limited by the communication links provided. Generally, the communication links are standard wire line, hardwired, or electronic port (e.g., RS-232) between the switching device and a communications managing computer processor. The devices of the related art, at best, provides a dedicated direct link that limits the speed of transfer by the maximum allowable transfer of the link. Further, the related art does not have the ability to maintain account records and billing information in real time. Most systems merely meter fees according to an extrapolation process resulting in only a quantitative guess of the bill. Also, several attempts have been made in the related art to show increases in data and information transfer speeds. These devices generally rely on a communications system to carry the signals.

The following listing of the related art represent the conventional approaches in response to the increasing demands of today's telecommunications industry. U.S. Pat. No. 5,473,679, to Laporta et al.; U.S. Pat. No. 5,373,553, to Mintz et al.; U.S. Pat. No. 5,384,840, to Blatchford et al.; U.S. Pat. No. 5,499,289, to Bruno et al.; U.S. Pat. No. 5,519,770, to Stein; U.S. Pat. No. 5,528,677, to Butler et al.; U.S. Pat. No. 5,070,525, to Szlam et al.; U.S. Pat. No. 4,866,763, to Cooper et al.; U.S. Pat. No. 5,509,063, to Crabtree et al.; U.S. Pat. No. 5,420,917, to Guzman; U.S. Pat. No. 5,442,689, to Buttitta et al.; U.S. Pat. No. 5,448,632, to Iyob et al.; U.S. Pat. No. 5,450,482, to Chen et al.; U.S. Pat. No. 5,467,388, to Redd, Jr. et al.; U.S. Pat. No. 4,756,019, to Szbicki; U.S. Pat. No. 5,526,414, to Bédard et al.; U.S. Pat. No. 5,333,189, to Clary et al.; U.S. Pat. No. 5,426,694, to Hebert; U.S. Pat. No. 5,509,058, to Sestak et al.; U.S. Pat. No. 5,179,550, to Simpson; U.S. Pat. No. 4,527,012, to Caplan et al.; U.S. Pat. No. 5,446,726, to Rostoker et al.; U.S. Pat. No. 4,706,280, to Barbare et al.; U.S. Pat. No. 4,782,517, to Bernardis et al.; U.S. Pat. No. 4,638,123, to Altendorfer et al.; U.S. Pat. No. 4,799,144, Parruck et la.; U.S. Pat. No. 5,598,409, to Madonna et al.; U.S. Pat. No. 5,323,452, to Dickman et al.; U.S. Pat. No. 4,654,845, to Mukerji.

In addition, the related art references generally employ an Asynchronous Transfer Mode technology (ATM). ATM has been defined as a high-speed cell-switching network technology for local area network (LAN's) and wide area networks (WAN's) that handles data and real time voice and video. It combines the high efficiency of packet switching used in data networks, with the guaranteed bandwidth of circuit switching used in voice networks. ATM is defined in the Broadband Integrated Services Data Network (BISDN) standard.

When and if implemented by the telephone companies, ATM will provide “bandwidth on demand” by charging customers for the amount of data they send rather than fixed-cost digital lines (DS1, DS3, etc.) that often go under utilized. Unlike leased lines, which are point to point, ATM can switch data to any ATM node worldwide. ATM data rates are scalable up into the gigabyte range. Initial rates from the ATM Forum are 45, 100 and 155 Mbps. Thus, ATM can be used to switch traffic from a 100 Mbps LAN to a 45 Mbps DS3 line.

ATM is currently used in Labs connecting high-speed workstations. It is probable that adapters for personal computers will be readily available by the end of year 2000. It is envisioned that ATM will become widely used for both Labs and Wacs. ATM works by chopping all traffic into 53-byte cells, or packets. The fixed-length packet allows very fast switches to be built, and the small packet size ensures that voice and video frames can be inserted into the stream often enough for real time transmission.

ATM can also encompass frame relay traffic by breaking up frame relay's variable-length frames into ATM cells. ATM provides network services at the same level as Ethernet and Token Ring (OSI layers 1 and 2). This technology has specific application in data and communication transfer. ATM is the first packet-switched technology designed from the ground up to support integrated voice, video, and data communications applications. It is well suited to high-speed wide area network (WAN) transmission bursts. ATM currently accommodates transmission speeds from 64 Kbps to 622 Mbps. ATM may support gigabit speeds in the future.

Also, the related art provides a general backdrop for utilizing the ATM technology with state of the art computer systems. For example, when combined with the ATM, an expansion communication peripheral increases speed and efficiency several times over. Such expansion cards use the PCI Local bus for personal computers that provides a high-speed data path between the CPU and peripheral devices (video, disk, network, etc.). There are typically three PCI expansion slots on the motherboard. There may also be one or two built-in PCI controllers Integrated Drive Electronics (IDE), small computer system interface (SCSI), network, etc.) on the motherboard.

In a personal computer (PC), the PCI bus coexists with the Industry Standard Architecture (ISA) or Extended Industry Standard Architecture (EISA) bus. ISA and EISA boards still plug into an ISA or EISA slot, while high-speed PCI boards plug into a PCI slot. PCI runs at 33 MHz, supports 32- and 64-bit data paths and bus mastering. The first PCs with PCI buses became available in late 1993. PCI is processor independent and is available for PCs, PowerPC's and other central processing units (CPU's). This architecture is sanctioned by the PCI special interest group (SIG), supported by over 100 manufacturers. Its chief designer and promoter is Intel.

Technically, the number of devices a PCI bus can handle depends on how it is designed and the electrical loads of the devices. It typically handles a maximum of 10 loads, a load having to do with inductance, capacitance and other electrical characteristics. The basic chipset uses three, leaving seven for peripherals. PCI devices built onto the motherboard use one load, and PCI expansion slots use 2, typically.

With respect to the present invention, there are no devices in the marketplace or prior art that provide the high speed throughput, telecommunications switching capability, combined with a full accounting system. Primarily, all commercial telecommunications systems used bulky switching devices and such devices require an allotted space of enormous magnitude. Generally, the allotted space includes an environmentally controlled enclosed room, several “T” span units, and a host of technicians for monitoring and maintaining this equipment. Additionally, more automated systems employ a “dumb” unit for establishing a switch function only to the line that it is dedicated to. These system types require less monitoring and maintenance however, the environmentally controlled enclosure is usually larger for supporting the additional dedicated lines and switches.

None of the above inventions and patents, taken either singularly or in combination, is seen to describe the instant invention as claimed. Thus a single computer based telecommunications system that is scalable and expandable, and greatly increases call/informational traffic through an ability to process and bill a mix of the most commonly known telephone protocols in real time is desired.

### SUMMARY OF THE INVENTION

A scalable and expandable single computer based telecommunications system for greatly increasing call/informational traffic through the system is set forth. This system, having an ability to process and bill a mix of the most commonly known telephone protocols in real time, provides a unique and cost effective solution in this disclosure and appended claims.

Accordingly, it is a principal object of the invention to provide a PCI bus based telecommunications switching system.

It is another object of the invention to provide system intelligence with the ability to recognize all incoming protocols and change any outgoing port to that protocol. This allows all ports to be “neutral” (i.e., non-dedicated), greatly improving the efficiency of the system.

It is another object of the invention to provide an ATM for establishing the switching functions within the system.

It is a further object of the invention to provide a real time billing sequence for each call in each call/informational protocol by time increments or by size of bandwidth.

Still another object of the invention is to provide a programmable call processing system.

It is an object of the invention to provide improved elements and arrangements thereof in a telecommunications switch with programmable call processing and real time account management for the purposes described which is inexpensive, dependable and fully effective in accomplishing its intended purposes.

These and other objects of the present invention will become readily apparent upon further review of the following specification and drawings.

The instant invention uses a unique combination of data communication and transfer protocols to produce a switching system that is versatile, economical, and programmable. Specifically, utilizing the PCI based data communicating bus and the ATM switching protocol, the instant invention is categorically a “virtual matrix” system and design of both hardware and software. Said matrix allows the system to function using software where in the past only hardware was and could have been used. The use of this matrix allows data movements at much higher speeds. Further, by utilizing a solely PCI bus, where hardware is required, the processing capabilities are not hampered by the tag lag generated between convention computer boards having a combination of PCI and standard ISA, EISA or VESA local buses. The use of the PCI bus based computer and the ATM switching devices, the ability to make account management in real time is accomplished. The present invention provides a comprehensive and flexible package for providing a high level of performance.

In the telephone industry, the ability to do real time processing, rating, and billing of calls in a sole computer based system is a key component to effective service. The present invention stores data in random access memory and uses interprocess communications between software modules instead of database access on disk. Test results reveal that a standard desktop personal computer operating as a host computer, according to the present invention, with the PCI bus based switch system processed telecommunications information is 10 orders of magnitude faster than conventional indexed database access systems.

The instant invention provides increased capacity as well as extreme flexibility. The PCI bus and the power of fast processors, which are currently available in personal computers, yield a telecommunications switch with a capacity on the order of 3360 ports or more, depending on the number of ports per card (effectively 140 conventional T's). Compared to the present state of the art, the instant invention is extremely fast, small and compact, flexible, user-friendly, and open-ended. The switch of the present invention operates in a “smart” state, capable of delivering least cost routing and real time rating of calls. In addition, the switch may be coupled to and under the command of a host computer. In this manner the host computer provides a programmability of the switch. Further, access to the switch may also be obtained remotely. This would alleviate most of the manpower presently necessary for maintenance and monitoring. Such access may be over modem, RS-232, microwave, or any of the other remote access devices, as found in prior art.

The switch of the present invention uses RAM disks as primary storage and retrieval media. The RAM disks provide a permanent storage for all essential files and programs. Unlike dynamic storage media, the RAM disk has no moving parts and will probably not crash for the life of the switch. The switch may also utilize standard storage media in an optional backup capacity, such as a RAID (redundant array of inexpensive disks or flash drives). The RAID primarily provides a store for call records and voice recordings because these types of files generally take substantial amounts of space.

In an alternate embodiment, the present invention provides channels in excess of 200 for state of the art communications. The increased volume of throughput is characterized by utilizing a multiplicity of selectable T1/E1 programmable peripheral cards carried on the PCI bus. A maximum of 240 channels are thereby provided for maximum flexibility without the degradation of the voice channels. The main PCI motherboard can route these voice channels over either one of two, or both backplane interfaces. The preferred two interfaces are a computer telephony bus or an ATM cell bus.

### BRIEF DESCRIPTION OF THE DRAWINGS

FIG. 1 is a block diagram of the primary and secondary PCI buses used in the switch according to the present invention.

FIG. 2 is a block diagram of the host computer and switch according to the present invention.

FIG. 3 is a block diagram of telecommunications switch system according to the present invention.

FIG. 4 is a block diagram of a peripheral card linking the primary and secondary buses of FIG. 1.

FIG. 5 is a block diagram of a telephony card used in the switch system according to the present invention.

FIG. 6 is a circuit diagram of an alternate PCI bus based telecommunications system utilizing a selectable T1/E1 peripheral card.

Similar reference characters denote corresponding features consistently throughout the attached drawings.

### DETAILED DESCRIPTION OF THE PREFERRED EMBODIMENT

The present invention is basically a passive backplane personal computer. The PC uses a primary PCI bus and a secondary PCI bus. Conventionally, a standard PCI bus requires a bridge at every four slots. The instant switch on the other hand, utilizes a compact PCI bus architecture, thereby requiring a bridge at every eight slots. The preferred switch embodiment has a maximum of 15 compact PCI bus slots.

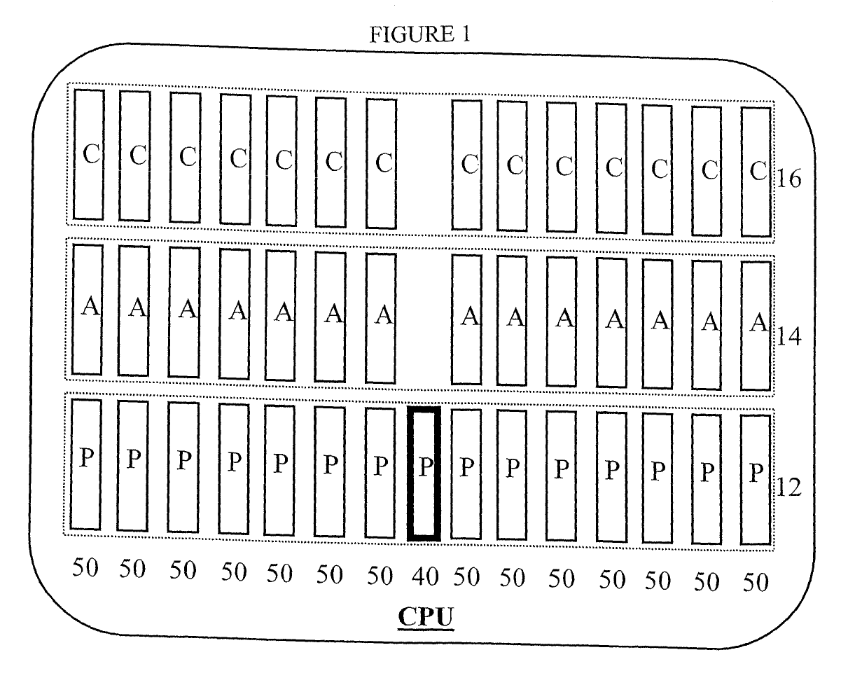

As seen in FIG. 1, a switch 10 has a primary bus 12 and a secondary buses; an ATM bus 14 and a CT bus 16. The primary bus 12 is designed to establish communications (sending and receiving commands and states) among telephony cards 50. The secondary buses 14, 16 are designed for passing the actual call. Since the entire switch bus 10 is compact PCI, the slots of primary bus 12 are labeled P while the slots of the ATM bus are labeled A, and the slots of the CT bus are labeled C. Generally, the primary bus 12 has a predetermined number of P slots, and the secondary buses 14, 16 have a predetermined number of A, C slots. The motherboard with the main CPU and RAM is carried in the center P slot. The RAM disk is carried in the main CPU P slot. An I/O card for TCP/IP and RS-232 port interfaces is also on the main CPU P slot. The optionally provided RAID has a controller carried in a P slot. The additional P slots are empty or reserved for additional devices.

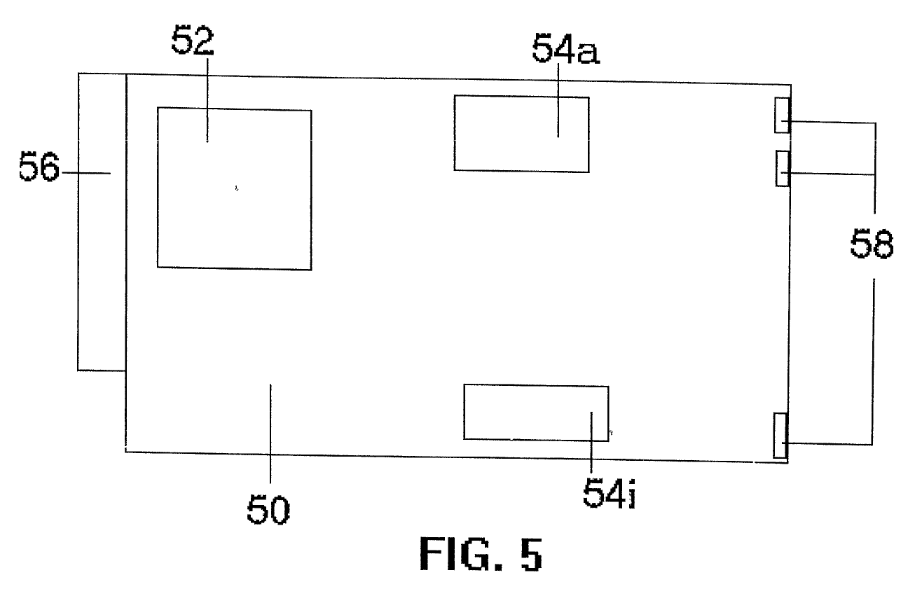

The A or C slots of the secondary bus, aside from the master card 40 (and backup), all carry telephony cards 50 (FIG. 5). The telephony cards use standard interfaces, such as T1, E1, ISDN, SS7, and analog cards. The present invention's system allows for any combination of cards to be used in the switch 10. Referring to FIG. 5, each telephony card 50 carries a plurality of jacks 58, typically 4 for a “small” switch or an amphanol connector in case of an 8 or 12 T's per card switch. Each telephony card 50 has its own microprocessor (μP) 52. In addition, the telephony cards 50 support a series of chipsets 54a-54i, where i=the number of activated chipsets 54. The microprocessor 52 controls the selection and function of the chipsets 54a-54i, and selects the telephony bus and channel used to connect a call. The card plugs into an A or C slot via compact PCI connector 56. All telephony cards have a ATM bus and CT bus insert 57 allowing each card to be plugged into a primary and secondary bus slot on the switch 10. The ATM bus and CT bus connect directly into the backplane.

All cards are “hot swappable”. Also, all cards are smart cards having their own processors to handle as much processing on their own, allowing transferring and processing to occur at greater speed and efficiency.

Alternatively, all ports or channels communicate directly with the ATM bus. In this manner the ATM bus converts all data signals into ATM cell packets and then submits them to the ATM bus. The cell bus device establishes the routing information to the headers of the ATM cell packets via the routing command it receives from the call processor and sends the packets back to the cell bus. The interface card deciphers the routing information and changes the ATM cell packets to the appropriate telephony protocol to send out the outgoing port. The data coming in from the outgoing port is not changed to ATM, but directly to the incoming port's protocol and sent out by the interface card without ever being sent to the cell bus. The advantage of this setup is that less of the RAM (regular or dual-port) is needed. The data transfer rate will depend on the speed of the cell bus.

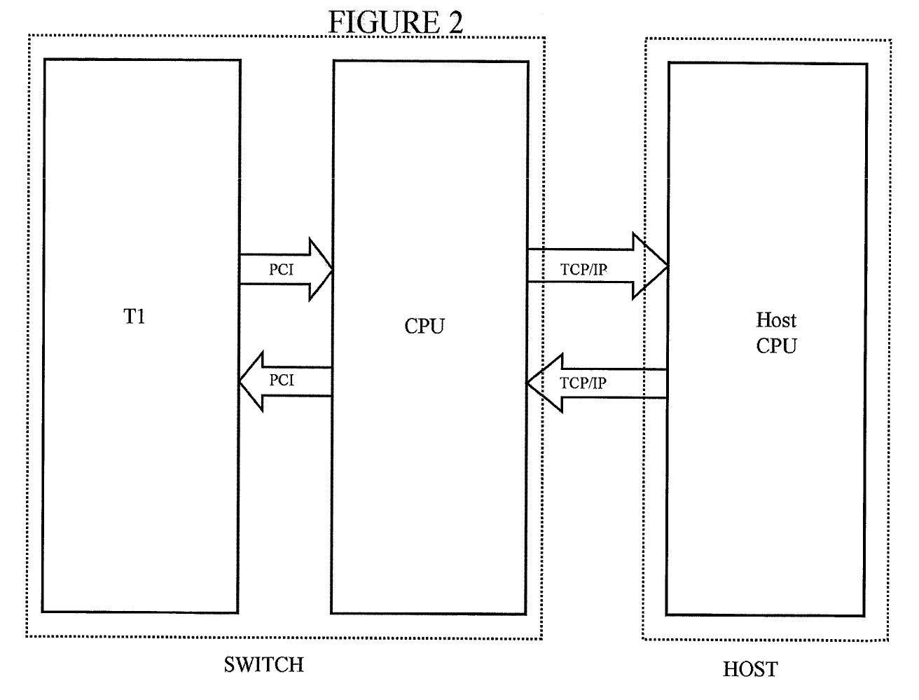

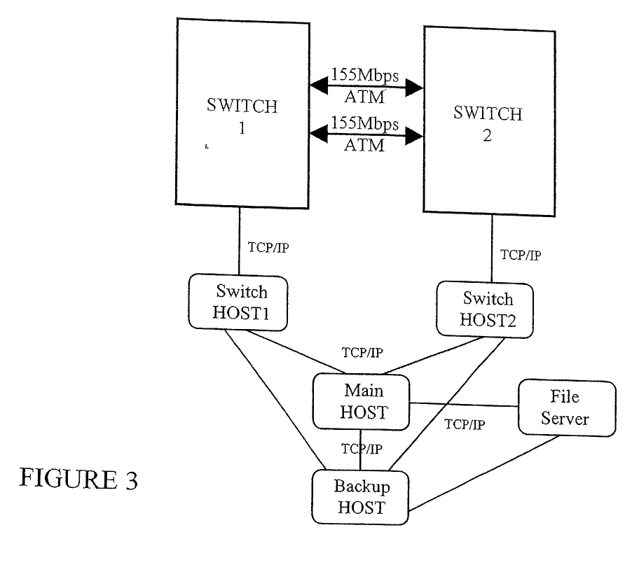

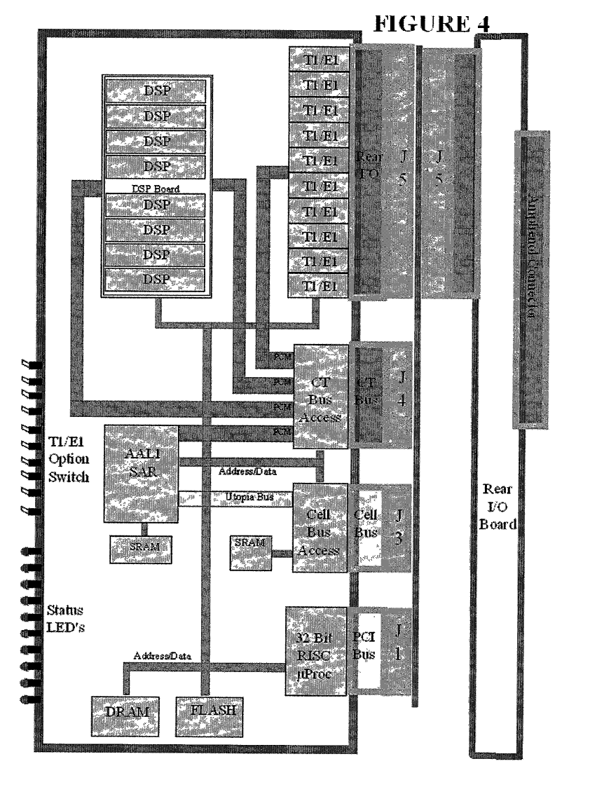

The switch system has several layers that is carried out by appropriate software. The following table sets the layers in a basic array for understanding the invention in conjunction with the following descriptions of FIGS. 2 and 3.

TABLE I
SWITCH

| | |
|---|---|
| Layer 1: | Physical interface to T1, E1, ISDN, |
| | SS7, analog cards to bus. |
| Layer 2: | Device driver or low level software interface to |
| | translate signals across networks, circuits, or |
| | lines. |
| Layer 3: | Translate low level signals from Layer 2 to higher |
| | level messages; |
| | translate higher level commands into low level |
| | driver instructions to control transfer of signals |
| | in Layer 2. |
| Layer 4: | Translate Layer 3 intermediate messages to generic |
| | high level messages; translate generic high |
| | level commands to Layer 3 intermediate |

### PRIMARY HOST COMPUTER

Layer 1: Physical link (communication port) to switch.

Layer 2: Device driver to interface with Layer 1.

Layer 3: Interface between Layers 2 and 4.

When interfacing with other programmable switches, Layer 3 translates these different switch messages into the generic high level messages and the generic high level commands into the various switch instructions.

Layer 4: Generic call-processing applications.

Referring to FIG. 2, block forms are used to show how switch 10 and host computer 22b and the elements thereof interact. The switch 10 has telephony cards 50 illustratively shown as a primary part of block 24. As seen in FIG. 1, these telephony cards 50 are simultaneously plugged into the primary and secondary buses (12, 14 and 16) found in the switch 10 and are designed for sending and receiving commands and states. Block 24 also includes, device drivers (which translate signals across networks, circuits, or lines), and software which handles the interface between lower level and higher level commands. In another words, layers 1, 2, and a portion of layer 3 of the switch section of Table I are accomplished in block 24. The remainder of layer 3 and layer 4 (the other side of the interface between lower level and higher level commands and all generic call processing applications) is carried out by block 26. An interface card 28a communicates to the host computer via complimentary interface card 28b. In block 28b, layer 1 and a portion of layer 2 of the host computer 22b from Table I are carried out. Block 30 represents the CPU of the host computer and it carries out the remaining portion of layer 2 and layers 3, and 4 of Table I.

Referring to FIG. 3, expanding non-blocking ports using the ATM chipsets. When multiple switches are linked together, ATM chipsets are utilized. The number of switches linked is dependent upon the number of lines being serviced. For illustrative purposes, such linking is described using just two switches. In order to join two switches together, namely blocks 32a and 10b, a telephony card is replaced in each switch by a 1×1 ATM card. When the switch 10a and switch 10b are joined together, a four link interface card is used on the primary host computer 36a having the two unused links disabled. A backup host computer 36b utilizes a multiple TCP/IP card, conventionally PCI compatible. The links between the primary host computer 36a and the file server 34a is conventionally a TCP/IP, likewise the link between the backup host computer 36a and the backup file server 34b is conventionally a TCP/IP. Finally, the link between the primary file server 34a and the backup file server 34b is also a TCP/IP. In the system illustrated it is conceived that the maximum number of ports or channels available for telecommunications exceeds 6240. More over, the total number of non-blocking ports at one instance approaches 5760 (requiring two ATM cards). This substantiates the linked switch system of FIG. 3 classifiable as non-blocking.

By using RAM drives in lieu of disk drives, all database access is therefore, on the file server 34a or backup file server 34b. The host computers 36a and 36b (primary and backup) each have a call processor and the realtime billing application. Everything else from user screens, invoicing, generating reports, etc., is accessed via the file servers 34a and 34b (primary and backup). It is evident that the system disclosed herein provides ample region to expand beyond the one or two switches (10, 10a, or 10b), but rather by utilizing the ATM and the high speed PCI data bus several switches may be linked. Further, speed is maximized by using RAM access instead of disk and have distributive processing with balanced loads.

In addition, an alternate embodiment is shown having a selectable T1/E1 peripheral card (not shown). With respect to the description of this embodiment, the following listing supplies the definitions of the nomenclature. AAL1 refers to an ATM (asynchronous transfer mode) Adaption Layer 1, where the ATM, as set forth above, includes a digital high-speed, high-volume, packet-switching transmission protocol standard. ATM uses short, uniform, 53-byte cells to divide data into efficient, manageable packets. Cell bus refers to a bus that is used to transport ATM cells between cards in the system. Compact PCI B is an industrial/ruggidized version of PCI bus standard, perfectly suited for environmental field dispositioning. Computer Telephony or CT Bus is a bus that transports 64 Kbps voice channels in the system. Digital Signal Processor or DSP is a specialized computer chip design to perform speedy and complex operations on digitized waveforms (e.g. audio signals). DTMF, Dual Tone Multi Frequency, the conventional technical term to describe the signal tones generated by touch tone dialing, wherein each button generates a double-frequency signal distinctive to that button. The interface E1 is the European standard for High Speed Transmission, it consists of 30 voice channels, each digitized at 64 Kbps, combined into a single 2.048 Mbps digital stream (128 Kbps signaling), and carried over two pairs of regular copper telephone wires.

FLASH ROM memory that is electrically erased and reprogrammed to allow ROM upgrades. ISDN, Integrated Services Digital Network, the set of standards for transmission of simultaneous voice, data and video information over fewer channels than would otherwise be needed, through the use of out-of-band signaling. The most common ISDN system provides one data and two voice circuits over a traditional copper wire pair, but can represent as many as 30 channels. Broadband ISDN extends the ISDN capabilities to services in the Gigabit range. Also, a digital network that permits the switched interconnection of voice, data, and video transmissions requiring differing capacities over common facilities. PCI, as set forth above, is a local bus that provides high-speed interconnection between the cards in a PC and the CPU. Reduced Instruction Set Computer, or RISC microprocessor that uses simplified operating commands to increase the speed of the microprocessors performance.

ROM (Read Only Memory)—The portion of computer memory that is programmed electrically by the manufacturer. It is unchangeable and is unaffected by power loss. SAR refers to Segmentation and Reassembly, the ATM functions that converts data into standard ATM cells for electronic communications transport. DRAM (i.e., Dynamic Random Access Memory) is memory that retains recorded information after main power is switched off. Signaling System 7, or SS7 is a dedicated out-of-band signaling standard that provides fast call setup and call processing information. The interface T1 is the US standard for High Speed Transmission, it consists of 24 voice channels, each digitized at 64 Kbps, combined into a single 1.544 Mbps digital stream (8 Kbps signaling), and carried over two pairs of regular copper telephone wires. The T1 and E1 cards are interchangeable within the system described herein as selectable T1/E1.

The peripheral card provides even faster and increased volume throughput. This peripheral card differs from the embodiment of FIG. 1 as follows. Each port is selectable as a T1 or an E1 interface. Unlike the above embodiment, albeit selectable yet requires all port interfaces to be either T1 or E1.

The peripheral card supports a total base maximum of 240 voice channels. Most modules support 1, 2, 4, or 8 interfaces max B which translates to 192 (8×24) voice channels for 8 T1 interfaces or 240 (8×30) voice channels for E1 interfaces. This module will support 240 (10×24) voice channels for T1 or 240 (8×30) voice channels for E1; providing maximum flexibility to select between T1/E1 interfaces with out being penalized on voice channels.

The peripheral card or module routes voice channels over two backplane interfaces: the Computer Telephony Bus (CT) and the Cell bus. The CT Bus is a bus that transports 64 Kbps voice channels in the system. While the Cell bus is a bus that is used to transport ATM cells between cards in the system. The CT bus supports 2048 channels or a maximum of 85 T1 interfaces or 68 E1 interfaces. The Cell bus supports 7560 channels (approx.) or a maximum of 315 T1 interfaces or 252 E1 interfaces. Other systems use only the CT bus and therefore have a maximum system size that is limited by the CT bus. This extra capacity allows for future expansion of higher density boards and it will also allow for system expansion by connecting multiple cabinets together either directly or through an ATM network/switch. The Cell bus is the preferred transport because it allows for easy migration to a mixed voice and data system, which is the current technological progression of communications.

A 10×T1 board consists of a main motherboard, at least 1 daughter card (for example, a digital signal processor or DSP) and a I/O board. The main motherboard includes at least the following components (note FIG. 6). A microprocessor (such as an Intel i960RD) is a 32 bit embedded 66 MHz RISC processor with a i960JF core. A backplane local PCI bus interface, and a memory controller. The backplane local PCI bus connects to an industrial, ruggidized version of PCI bus standard, such as a Compact PCI bus via a backplane Compact PCI connector. The Compact PCI bus communicates with the Switch CPU as well as other conventional telephony systems. The memory controller is a conventional interface to DRAM and FLASH memory devices. DRAM or FLASH memory provides the memory storage for the 32-bit processor. FLASH memory is preferred by virtue of its reprogramability which enables firmware upgrades.

The T1 card (preferably a PM4351) provides a maximum 10 T1/E1 interfaces, however only 240 channels are currently supported (limited by AAL1 SAR & CT BUS). Therefore, a maximum of 240 T1 channels (i.e., 10 T1 ports per slot×24 channels per port) or a maximum of 240 E1 channels (i.e., 8 E1 ports per slot×30 channels per port) are provided via either the T1 or E1 interfaces. Mixed combinations of E1 and T1 ports are allowed as long as the total number of channels does not exceed 240. Each port is selectable as T1 or E1 by setting an option switch on the front of the module. The physical interface to the T1/E1 module is made with an amphenol connector that sits on the I/O board. For a full-blown switch with all T1s, the maximum number of nonblocking channels possible is 3360 (14 available T1 slots×10 T1 ports per slot×24 channels per port) and 3360 for E1s (14 available E1 slots×8 E1 ports per slot×30 channels per port).

The CT Bus Access this device (typically a Lucent T8105) provides an interface the to Compact PCI connector J4 and also provides the interface to the CT Bus and operates as a distributed matrix switch. The CT bus carries 64 Kbps voice signals. The CT bus connects through Compact PCI connector J4 to the backplane to transfer data with other peripheral boards. This is a standard application of J4 as defined in the Telephony Compact PCI standard. The Cell Bus Access this device (for example, a Transwitch Cubit) provides the interface to the ATM. Thus the Cell Bus 608 operates as a distributed matrix switch. The cell bus carries packets of voice and or data. The cell bus connects through Compact PCI connector J3 to the backplane to transfer data with other peripheral boards. The use of J3 as a Cell bus on a Compact PCI backplane enhances the faster and increased volume throughput. The AAL1 SAR (in this preferred embodiment, a Mitel MT90500) converts standard 64 Kbps voice streams into ATM cells and vice versa. The AAL1 SAR interfaces to the Cell Bus Access device via the UTOPIA ATM interface. The digital signal processing daughter board contains several DSPs (i.e., DSP 16210) to provide DTMF and MF detection, DTMF and MF generation and other miscellaneous telephony communication tasks.

The rear I/O module B this module connects to Compact PCI connector J5 and provides an amphenol connector to connect to the T1/E1 CO lines. Such is a conventional application of J5 in the Telephony Compact PCI standard. The module shown could be used to connect PCI data/voice over the T1/DS1 interface or onto the Cell bus. Likewise, it may also be used for ISDN D-channel, X.25, frame relay or SS7 Signaling control.

It is to be understood that the present invention is not limited to the embodiments described above, but encompasses any and all embodiments within the scope of the following claims.

I claim:

1. A programmable telecommunications switching system comprising:
a computer including a main bus, at least one backplane, microprocessor carried on said main bus for processing communication functions and controlling transferring data;
a plurality of expansion cards coupled to said main bus, wherein each expansion card includes a digital signal processor for preprocessing waveform data for maximizing the transfer of said waveform data, said expansion cards are selectable T1/E1 telephony cards; and
said main bus being a peripheral component interconnect bus;
wherein said at least one backplane is chosen from the group consisting essentially of a computer telephony bus, a cell or ATM or CT bus, and a computer telephony and cell combined bus.

2. The programmable telecommunications switching system according to claim 1, each of said selectable T1/E1 telephony cards provides a maximum of 30 voice channels.

3. The programmable telecommunications switching system according to claim 2, each of said selectable T1/E1 telephony cards provides at least a minimum of 24 voice channels.

4. The programmable telecommunications switching system according to claim 3, each of said selectable T1/E1 telephony cards producing a single digital voice/data stream in the range of 1.544 to 2.048 Mbps, carried over standard pairs of copper wire.

5. The programmable telecommunications switching system according to claim 1, said computer further including memory, wherein said memory is chosen from the group consisting essentially of FLASH ROM and DRAM.

6. The programmable telecommunications switching system according to claim 5, said microprocessor includes a reduced instruction set computer.

7. The programmable telecommunications switching system according to claim 1, wherein said system acts as a virtual matrix.

8. The programmable telecommunications switching system according to claim 1, wherein said matrix is capable of accepting any input protocol.

9. The programmable telecommunications switching system according to claim 1, wherein said matrix is capable of outputting any protocol.

10. The programmable telecommunications switching system according to claim 1, wherein said matrix is capable translating any of said input protocol to any of said other output protocol.

11. The programmable telecommunications switching system according to claim 1, wherein said translation is enabled through the use of an internal ATM or cell Bus.

12. The programmable telecommunications switching system according to claim 1, wherein said backplane can pass commands or states or calls.

13. The programmable telecommunications switching system according to claim 1, wherein said matrix is capable of handling at least as many as 3360 input and output ports.

14. The programmable telecommunications switching system according to claim 7, wherein said matrix has only software switches.

15. The programmable telecommunications switching system according to claim 14, wherein said matrix processes all switching functions in RAM.

16. The programmable telecommunications switching system according to claim 1, wherein said matrix is programable;

17. The programmable telecommunications switching system according to claim 15, wherein said matrix may be accessed remotely.

18. The programmable telecommunications switching system according to claim 1, wherein said matrix is monitored by a billing system.

19. The programmable telecommunications switching system according to claim 17, wherein said billing system works in real time.

20. The programmable telecommunications switching system according to claim 1, wherein said matrix is monitored by a diagnostics system;

21. The programmable telecommunications switching system according to claim 1, wherein said diagnostics system works in real time.
